(19) United States
(12) Patent Application Publication
(10) Pub. No.: US 2010/0042232 A1
(43) Pub. Date: Feb. 18, 2010

(54) Method for operating an industrial plant

(76) Inventors: Andreas Hildebrand, Deutschland (DE); Thomas Helm, Deutschland (DE); Oliver Seydell, Deutschland (DE); Andreas Pirsing, Deutschland (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/919,092

(22) PCT Filed: Apr. 21, 2006
(86) PCT No.: PCT/EP2006/061764

§ 371 Date: Oct. 26, 2009

(30) Foreign Application Priority Data
Apr. 25, 2005 (DE) 10 2005 019 427.3

(51) Int. Cl. G06F 19/00

(52) U.S. Cl. 700/79

(57) ABSTRACT

A process is disclosed for operating an industrial plant by means of a guidance system that controls processes in the industrial plant, in which process operation-relevant data such as states, malfunctions and/or degradation of devices of the industrial plant are acquired by an operator; the operation-relevant data are acquired in an operation monitoring system and stored in electronic, preferably standardized form, and operation-relevant data on events which can affect process control, such as malfunctions of devices, are electronically transmitted to the guidance system. Operation-relevant data and events can thus be reliably archived, documented and made available to the operators of the industrial plant, it being ensured that process-relevant data are taken into account in the guidance system even when said data relate to devices which are not connected to the guidance system

### CROSS REFERENCE TO RELATED APPLICATIONS

This application is the US National Stage of International Application No. PCT/EP2006/061764, filed Apr. 21, 2006 and claims the benefit thereof. The International Application claims the benefits of German application No. 10 2005 019 427.3 filed Apr. 25, 2005, both of the applications are incorporated by reference herein in their entirety.

### FIELD OF INVENTION

The invention relates to a method for operating an industrial plant by means of a control system that controls processes in the industrial plant, with operationally-relevant data being acquired by an operator of the industrial plant. The invention also relates to a corresponding device.

### BACKGROUND OF THE INVENTION

Events observed by the plant personnel, in other words by an operator of the industrial plant, such as the failure of a plant component for example, have hitherto been written down in handwritten form in so-called operational logs. This approach is inherently disadvantageous because the operational log must always be physically present for inspection and can thus only be inspected in the plant control room. The entry made in the operational log also does not adequately ensure that operationally-relevant data, for example concerning temporary operational degradation, actually has some influence on the process control functions.

### SUMMARY OF INVENTION

The object of the invention is to avoid the disadvantages described above and to provide an improved method for operating an industrial plant, and also a corresponding device.

The object is achieved by a method mentioned in the introduction, in which the operationally-relevant data is acquired in an operation monitoring system and is stored in electronic form, with operationally-relevant data concerning events which affect process control being transmitted electronically to the control system. This makes operation of the industrial plant considerably safer and more reliable.

Advantageously, the operationally-relevant data is stored in a database of the operation monitoring system.

Preferably operationally-relevant data relating to devices of the industrial plant that are not attached to the control system is acquired and stored.

By preference, during process control the control system takes into consideration temporary degradation affecting devices as a result of the operationally-relevant data provided by the operation monitoring system.

Advantageously, operationally-relevant data can be displayed in a situation-related manner with the aid of the operation monitoring system.

By preference, operationally-relevant data can be displayed decentrally with the aid of the operation monitoring system.

Advantageously, the operator of the industrial plant can acquire operationally-relevant data by means of a terminal.

By preference, the operator can acquire operationally-relevant data by means of a mobile communication unit.

Advantageously, the operator can acquire operationally-relevant data in a non-contact manner by means of a mobile reader unit.

The object of the invention is also achieved by a device for carrying out the method described in its different embodiments in the above, with a control system, with at least one interface module and with an operation monitoring system, whereby the operation monitoring system is coupled by way of the at least one interface module to the control system.

By preference, the operation monitoring system has a monitoring module and at least one database.

### BRIEF DESCRIPTION OF THE DRAWINGS

Details and further advantages of the invention will be described in the following with reference to examples in conjunction with the drawings. In the drawings:

FIG. 1 shows a schematic view of the inventive interaction between operation monitoring system and control system for process control purposes, and

FIG. 2 shows a schematic view of one part of a configuration of a control system.

### DETAILED DESCRIPTION OF INVENTION

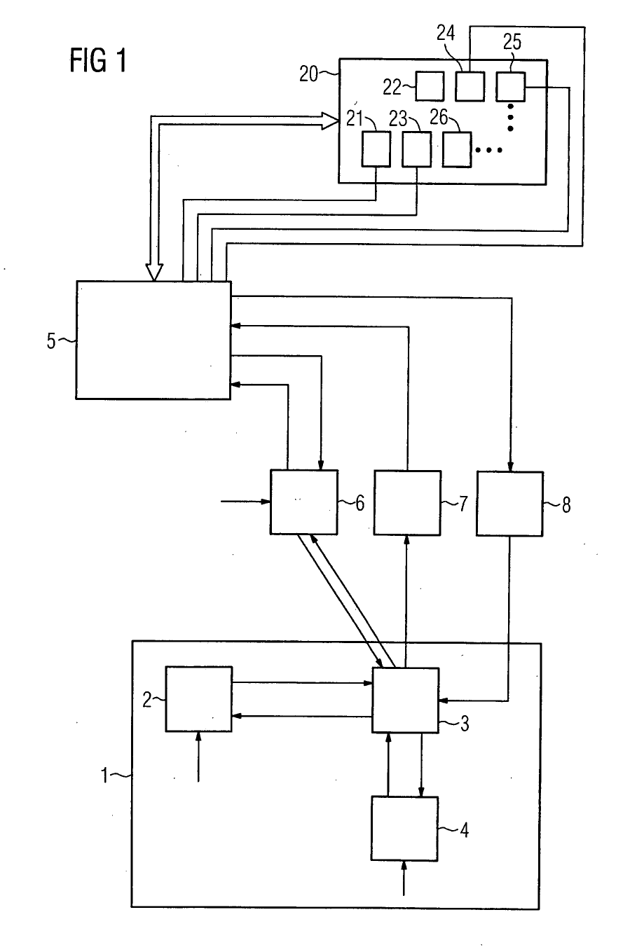

FIG. 1 shows a schematic view of the inventive operation monitoring system 1 which is coupled by way of interface modules 6, 7 and/or 8 to a control system 5 for process control purposes in the industrial plant 20. With regard to the industrial plant 20, this can for example be a sewage network, a sewage treatment plant, a plant for waste processing and/or disposal, a plant for the paper industry, a plant for the metal industry or a refinery. The above list of examples for the industrial plant 20 is not exclusive. The industrial plant 20 comprises a plurality of devices 21-26. One or more processes take place in the industrial plant 20, whereby one or more devices 21-26 are involved in the process cycle.

In order to control the process or processes taking place in the industrial plant 20 the control system 5 is coupled to the industrial plant 20. At least one section of the devices 21 to 26 of the industrial plant 20 is coupled to the control system 5. The devices 21, 23, 24, 25 coupled to the control system 5 are preferably integrated into one or more automation systems, by means of which the connection of the device 21, 23, 24, 25 to the control system 5 is established.

The operation monitoring system 1 preferably comprises a monitoring module 2, a database 3 and where applicable additionally a configuration module 4. Operationally-relevant data relating to the industrial plant 20 can be acquired in the operation monitoring system by, for example, being entered manually into the monitoring module 2 by an operator of the industrial plant 20. Within the operation monitoring system 1, operationally-relevant data is preferably stored in the database 3 which can be implemented for example in the form of an SQL server. The configuration module 4 permits manual parameterization of the operation monitoring system 1. By way of the configuration module 4 it is possible to set parameters in, or read parameters from, the database 3.

The operation monitoring system 1 is coupled to the control system 5 by way of one or more interface modules 6, 7 and 8.

Process-relevant data is stored in electronic form and preferably in standardized format in the database 3 after it has been acquired with the aid of the monitoring module 2. Operationally-relevant data concerning events which can affect process control or the process cycle in the industrial plant 20 is for example data relating to malfunctions or temporary degradation of devices 21-26 of the industrial plant 20. It is thus possible for example for an operator of a sewage network control facility to ascertain that a valve in a sewage network, which is possibly not incorporated into an automation system, cannot be completely closed or opened. The operator could also ascertain that a valve is situated in an unintended position and/or that a valve temporarily cannot be moved from its position. An operator of a plant in the metal industry, for example an operator of a rolling mill, could ascertain that the drive of a roll stand temporarily can only be run at a limited rotational speed.

Operationally-relevant data concerning events which can affect process control or the process cycle in the industrial plant 20 is transferred in electronic form, preferably by way of the interface module 6 to the control system 5. With the aid of the interface module 6, such data can be transferred to the control system 5 in a data format which can be processed by the control system, but can also in the appropriate circumstances conversely be read out from the control system 5 and stored in the database 3 of the operation monitoring system 1. Trigger signals for particular operations can be transferred to the control system 5 by means of the interface module 7. With the aid of the interface module 8, entries can be read out from the reporting system of the control system 5 and stored in the database 3. It can be advantageous for manual inputs which require access to the control system 5 and/or to the operation monitoring system 1 to be performed by an operator of the industrial plant 20 by way of an interface module 6.

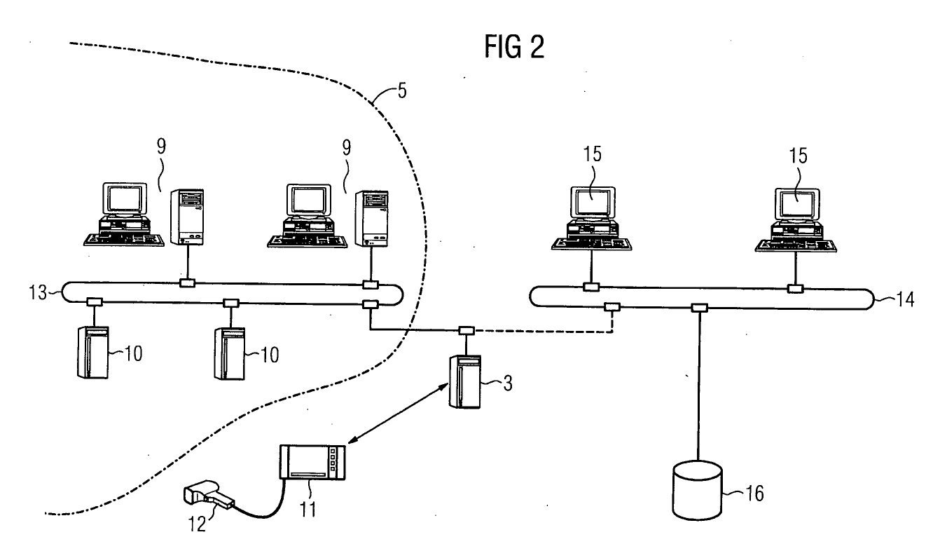

FIG. 2 shows a plurality of terminals 9 which are connected with one another and with servers 10 of the control system 5 by way of a terminal bus 13. The terminals 9 of the control system 5 serve as an interface between the operators of the industrial plant 20 and the control system 5. The manual input of operationally-relevant data into the monitoring module 2 (see FIG. 1) is preferably also possible by way of the terminals 9. The database 3 of the operation monitoring system 1 (see FIG. 1) is preferably coupled to the terminal bus 13 of the control system 5. The acquisition of operationally-relevant data can for example also take place by way of a mobile communication unit 11. Operationally-relevant data can preferably also be acquired in a non-contact manner by means of a reader unit 12. The mobile communication unit 11 can be connected to a reader unit 12 for the purpose of non-contact data acquisition. Data exchange between the mobile communication unit 11 and the database 3 can for example take place with the aid of an infrared link, a Bluetooth link, one or more storage media and/or with the aid of one or more wireless networks (WLAN for example).

The acquisition of operationally-relevant data, in other words the input of data into the operation monitoring system 1, takes place according to the invention in a defined format.

The database 3 can also be connected to a bus system 14 which does not form part of the control system 5. To the bus system 14 are attached one or more terminals 15 which can be used in order to acquire certain inputs of operationally-relevant data for the operation monitoring system 1 (see FIG. 1). The bus system 14 can also be used for connecting one or more external databases 16, an SAE database for example.

Operationally-relevant data concerning events which affect process control is, as stated previously, for example operational degradation of a device 21-26 of the industrial plant 20. If for example a device 22, 26 not attached directly to the control system 5 is malfunctioning or in a state not known to the control system 5, this can have effects on other devices 21-26 of the industrial plant. Temporary operational degradation which exists in the industrial plant 20 and is ascertained by an operator can furthermore be verifiably documented by means of the operation monitoring system 1.

The operation monitoring system 1 is preferably implemented as a computer program capable of running on a terminal 9 or 15. By preference, the operation monitoring system 1 can be operated by way of input and output devices, terminals 9 of the control system 5 for example. Archiving of operationally-relevant data in terms of pertinent legal guidelines can take place in the database 3. The operation monitoring system 1 can also be used for the electronic acquisition of shift book entries.

Operationally-relevant data, such as important degradation for example, can be displayed decentrally, for example on one or more of the terminals 9 or 15. The display of operationally-relevant data can in particular also take place in a situation-related manner, in other words for example in the form of an alarm or on interrogation of information associated with the operationally-relevant data by an operator of the industrial plant 20.

With the aid of the operation monitoring system 1, operational processes can be documented with reference to one or more devices 21-26 of the industrial plant 20. Operationally-relevant data can also be filtered and searched by means of the monitoring module 2. The operation monitoring system 1 can also be used for maintenance and service management.

The basic concept underlying the invention can be summarized as follows:

The invention relates to a method for operating an industrial plant 20 by means of a control system 5 that controls processes in the industrial plant 20, whereby operationally-relevant data such as states, malfunctions and/or degradation of devices 21-26 of the industrial plant 20 is acquired by an operator, whereby the operationally-relevant data is acquired in an operation monitoring system 1 and is stored in electronic, preferably standardized form, in other words in a defined format, whereby operationally-relevant data concerning events which can affect process control, such as for example degradation of devices 21-26, is transmitted electronically to the control system 5. Operationally-relevant data and events can thus be reliably archived, documented and made available to the operators of the industrial plant 20, it being ensured that process-relevant data is taken into account in the control system 5 even when said data relates to devices 22 or 26 which are not attached to the control system 5.

1.-11. (canceled)

12. A method for operating an industrial plant by a control system that controls processes in the industrial plant, comprising:
acquiring by an operator of the industrial plant in an operation monitoring system operationally-relevant data concerning events affecting process control relating to devices of the industrial plant that are not attached to the control system;
storing the operationally-relevant data in electronic form;
transmitting electronically operationally-relevant data concerning events affecting process control to the control system.

13. The method as claimed in claim 12, wherein the operationally-relevant data is stored in a database of the operation monitoring system.

14. The method as claimed in claim 13, wherein the control system during process control considers temporary degradation affecting devices as a result of the operationally-relevant data provided by the operation monitoring system.

15. The method as claimed in claim 14, wherein operationally-relevant data is displayed in a situation-related manner with the aid of the operation monitoring system.

16. The method as claimed in claim 15, wherein operationally-relevant data is displayed decentrally with the aid of the operation monitoring system.

17. The method as claimed in claim 16, wherein the operator acquires operationally-relevant data via a terminal.

18. The method as claimed in claim 17, wherein the operator acquires operationally-relevant data via a mobile communication unit.

19. The method as claimed in claim 18, wherein the operator acquires operationally-relevant data by a mobile reader unit in a non-contact manner.

20. A device for operating an industrial plant, comprising:
a control system with an interface module; and
an operation monitoring system coupled via an interface module to the control system where the operation monitoring system has a monitoring module for the acquisition of operationally-relevant data relating to devices that are not attached to the control system.

21. The device as claimed in claim 20, wherein the operation monitoring system has a database.
